(19) United States
(12) Patent Application Publication
(10) Pub. No.: US 2013/0015266 A1
(43) Pub. Date: Jan. 17, 2013

(54) SPRAY WASHER WITH A SOAP NOZZLE

(71) Applicants: Chris Riley, Madison, IN (US); Thomas Smith, Winfield, IL (US)

(72) Inventors: Chris Riley, Madison, IN (US); Thomas Smith, Winfield, IL (US)

(21) Appl. No.: 13/183,107

(22) Filed: Jul. 14, 2011

(51) Int. Cl. B05B 9/01

(52) U.S. Cl. 239/302

(57) ABSTRACT

A spray washer including a dispensing assembly having a water inlet connected to a pressurized water source, a spray outlet and a water actuator movable between a rest position and a dispensing position. When the water actuator is moved to the dispensing position, water from the pressurized water source enters the water inlet, flows through the dispensing assembly and exits from the spray outlet. The spray washer includes a soap reservoir having a soap outlet and in communication with the dispensing assembly, and a soap actuator movable between a rest position, where the soap outlet is closed off and clean, soap free water exits the spray outlet, and a dispensing position, where the soap outlet is at least partially open and a combination of water and soap exits the spray outlet.

### FIELD OF THE INVENTION

The present invention relates generally to spray washers that spray a stream of water onto an item, and more specifically, to spray washers that dispense soap.

### BACKGROUND

Conventional spray washers are used for cleaning various items such as decks, siding and cars, and are typically attached to a pressurized water source such as a hose. Some spray washers include a reservoir for storing liquid soap from which the soap is conveyed for subsequent mixing with the pressurized water stream during the washing process. In such spray washers, the soap is typically dispensed from the storage compartment when a user pushes or presses an actuator such as a button or trigger. Releasing the button stops the supply of soap to the water stream so that soap-free water is sprayed onto the item for rinsing.

A common problem with conventional spray washers is that a certain amount of soap remains in the water line after the soaping process is finished, i.e., after the button is released. As a result, the spray washer continues to dispense soapy water for a period of time after the soap button is released, which wastes soap. Furthermore, additional time is spent by a user waiting for the soap to dissipate before they can begin the rinsing process.

Accordingly, there is a need for a spray washer including soap that quickly and efficiently sprays the soap and water onto an item.

### SUMMARY

The present spray washer connects to a pressurized water source and sprays water or a mixture of water and soap from a nozzle for cleaning and rinsing items. Specifically, the present spray washer is configured to spray a “clean rinse” on an item by quickly and efficiently closing off the soap supply to the spray washer so that there is no residual soap in the water flow path. Closing off the soap supply in this manner conserves soap, time and money during the cleaning and rinsing processes.

More specifically, a spray washer is provided that includes a dispensing assembly having a water inlet connected to a pressurized water source, a spray outlet and a water actuator movable between a rest position and a dispensing position. When the water actuator is moved to the dispensing position, water from the pressurized water source enters the water inlet, flows through the dispensing assembly and exits from the spray outlet. The spray washer includes a soap reservoir having a soap outlet and in communication with the dispensing assembly, and a soap actuator movable between a rest position and a dispensing position, where when said soap actuator is moved from the dispensing position to the rest position, the soap outlet is closed off and soap-free water exits the spray outlet.

In another embodiment, a handheld spray washer is provided and includes a housing and a dispensing assembly positioned in the housing where the dispensing assembly includes a water inlet connected to a pressurized water source and a spray outlet. The dispensing assembly also includes a water actuator movable between a rest position and a dispensing position, where when the water actuator is moved to the dispensing position, water from the pressurized water source enters the water inlet, flows through the dispensing assembly and exits from the spray outlet. A soap reservoir including a soap outlet is positioned in the housing and is in communication with the dispensing assembly. A soap actuator is movable between a rest position, where the soap outlet is closed off from the dispensing assembly, and a dispensing position, where the soap outlet is at least partially open to the dispensing assembly. When the soap actuator is moved to the dispensing position, soap is drawn from the soap reservoir and mixed with the water flowing through the dispensing assembly by a vacuum created within the dispensing assembly.

In a further embodiment, a handheld spray washer is provided and includes a housing, a dispensing assembly positioned in the housing and connected to a pressurized water source and a soap reservoir positioned in the housing and in communication with the dispensing assembly. A water actuator is movably connected to the dispensing assembly and configured to control a valve in the dispensing assembly. The water actuator is movable between a rest position, where the valve is in a closed position and water is prevented from entering the dispensing assembly, and a dispensing position, where the valve is in an open position to allow water to enter the dispensing assembly. A soap actuator is movably connected to the dispensing assembly and is movable between a rest position, where the reservoir is sealed and soap is prevented from entering the dispensing assembly, and a dispensing position, where the reservoir is not sealed and the soap is drawn into the dispensing assembly by a vacuum. A nozzle assembly is connected to the dispensing assembly for directing water flowing through the dispensing assembly or a combination of water and soap onto an item when one of the water actuator and a combination of the water actuator and the soap actuator are moved from the rest position to the dispensing position.

### BRIEF DESCRIPTION OF THE DRAWINGS

FIG. 1 is a perspective view of an embodiment of the present spray washer;

FIG. 2 is a top view of the spray washer of FIG. 1;

FIG. 3 is a bottom view of the spray washer of FIG. 1;

FIG. 4 is an exploded perspective view of the dispensing assembly and housing of the spray washer of FIG. 1;

FIG. 5 is a perspective view of a first housing member of the spray washer of FIG. 1;

FIG. 6 is a perspective view of a second housing member of the spray washer of FIG. 1;

FIG. 7 is a perspective view of the second housing member of FIG. 6 including the dispensing assembly;

FIG. 7A is a schematic view of the soap reservoir, the soap dispensing tube and the soap receiving member shown in FIG. 7;

FIG. 8 is a perspective view of the assembled dispensing assembly of FIG. 4;

FIG. 9 is an exploded perspective view of the nozzle assembly of FIGS. 1-3;

FIG. 10 is an exploded perspective view of the adjustable handle assembly of the spray washer of FIG. 1;

FIG. 11 is an exploded, fragmentary perspective view of the adjustable nozzle of the spray washer of FIG. 1;

FIG. 12 is a fragmentary view of the spray washer of FIG. 1 where the water and soap actuators are in the “off” position;

FIG. 13 is a fragmentary view of the spray washer of FIG. 1 where the water actuator is in the “on” position and the soap actuator is in the “off” position; and

FIG. 14 is a fragmentary view of the spray washer of FIG. 1 where both the water and the soap actuators are in the “on” position.

### DETAILED DESCRIPTION

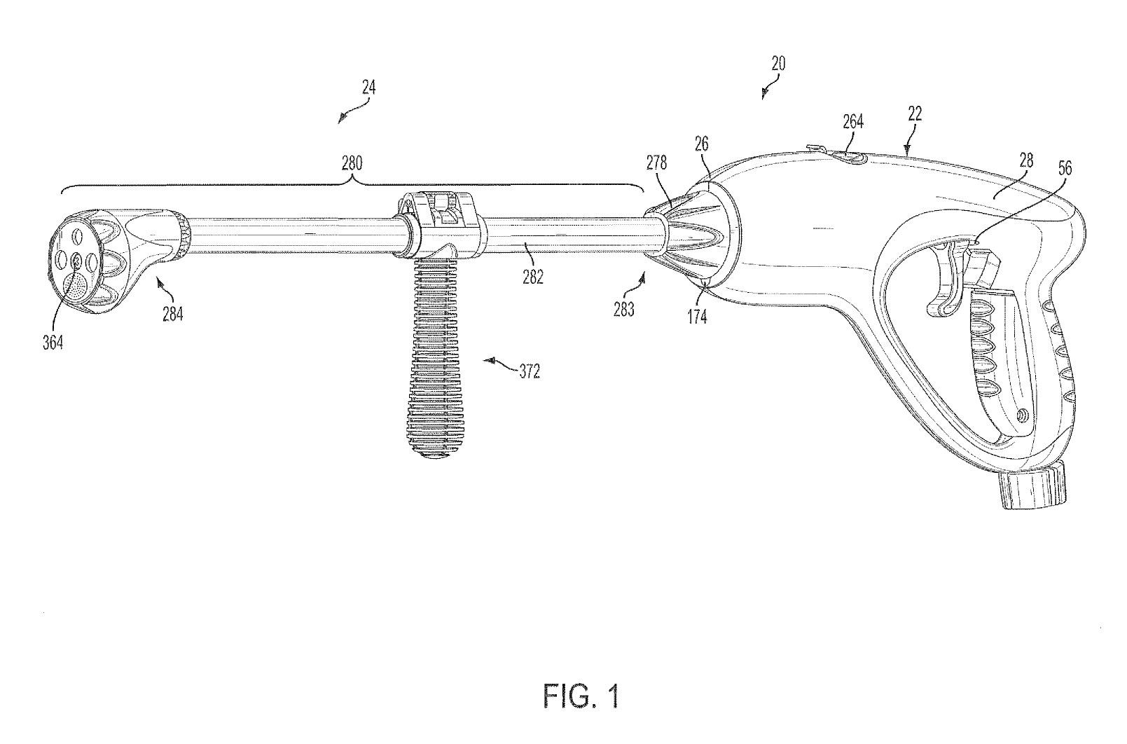

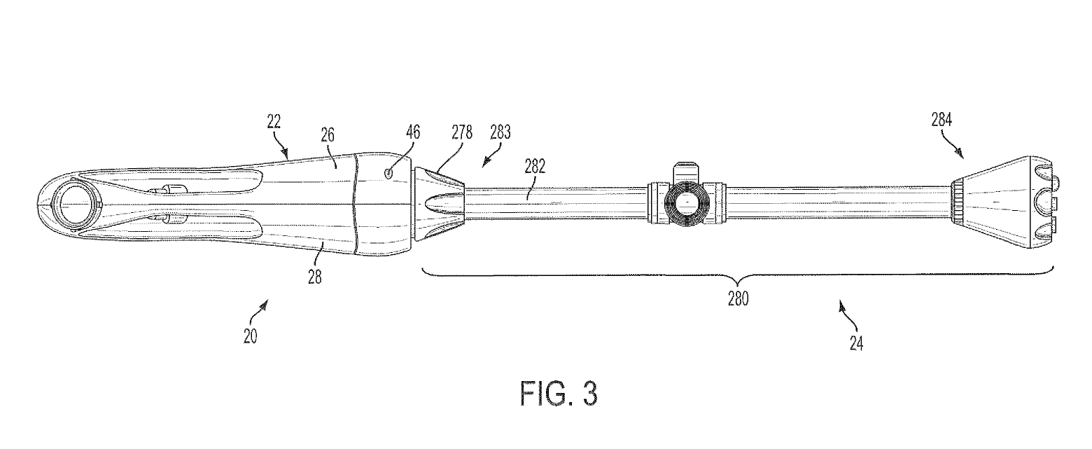

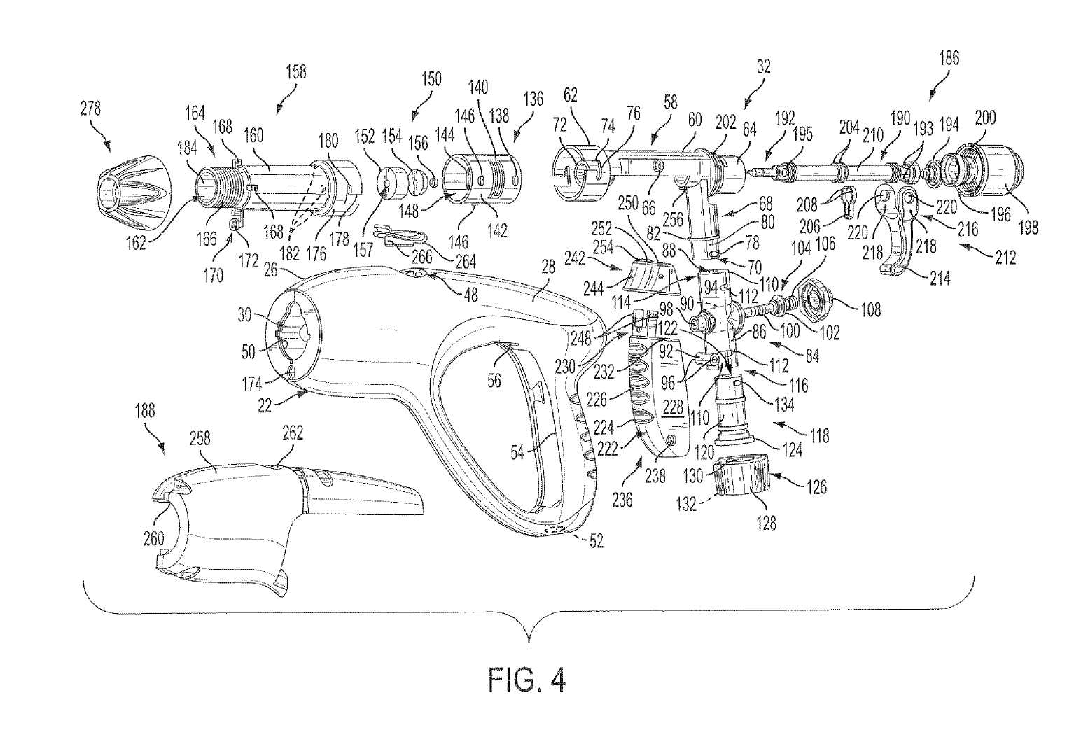

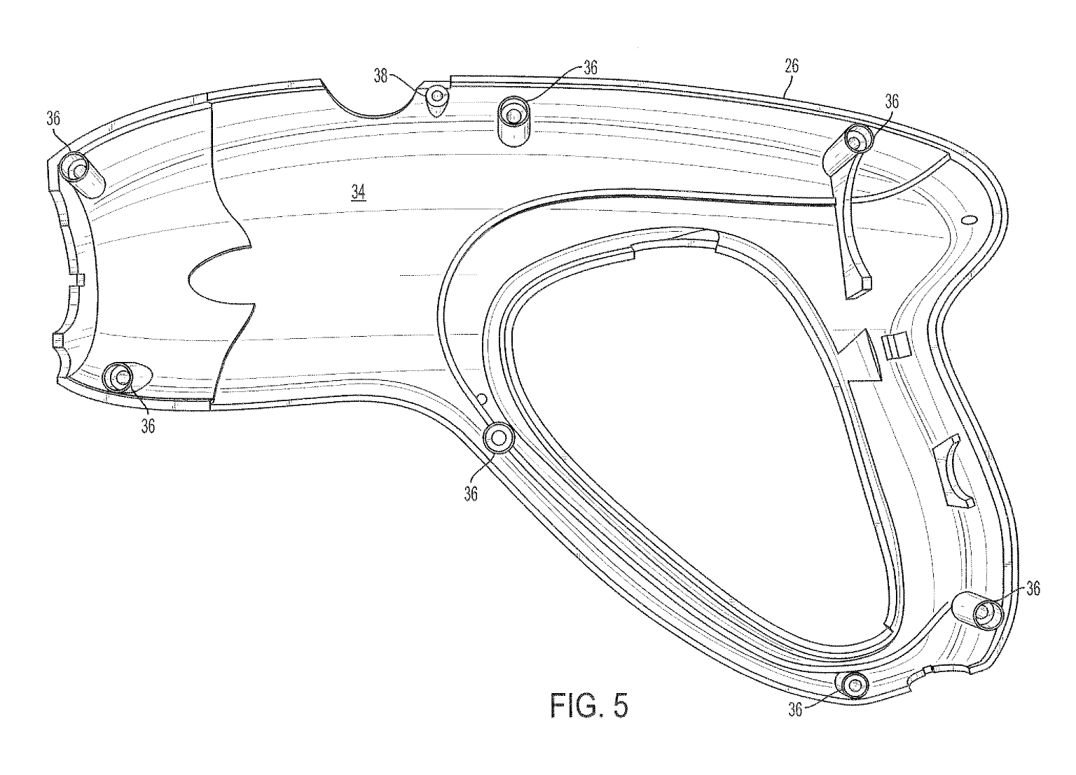

Referring now to FIGS. 1-6, the present spray washer 20 includes a housing 22 and a nozzle assembly 24 removably connected to the housing. The housing 22 is formed by connecting a first housing member 26 and a second housing member 28 together to form a hollow, internal chamber 30 (FIG. 4). A dispensing assembly 32 for controlling the flow of water through the spray washer 20 is inserted into the chamber 30 and is secured in place when the first housing member 26 and the second housing member 28 are connected together. As shown in FIG. 5, the first housing member 26 includes an inner surface 34, a plurality of cylindrical female bosses 36 projecting from the inner surface about the periphery of the first housing member and pin boss 38 projecting from the inner surface 34 near the top of the first housing member.

To secure the first and second housing members together, the second housing member 28 includes an inner surface 40 and a plurality of male bosses 42 projecting from the inner surface that matingly engage corresponding female bosses 36 on the first housing member 26. A cylindrical pin 44 also projects from the inner surface 40 near the top of the second housing member 28 and matingly engages the pin boss 38 on the first housing member 26. This structure is used to pivotably secure a cover, described later. After connecting the first and second housing members 26 and 28, each connected female boss 36 and male boss 42 defines a through-hole 46. A fastener, such as a screw (not shown), is inserted into each of the through-holes 46 for securing the bosses 36 and 42 together. As shown in FIG. 4, once assembled, the housing 22 defines a top opening 48, a front opening 50, a bottom opening 52, a handle opening 54 and a trigger opening 56, which are described in more detail below.

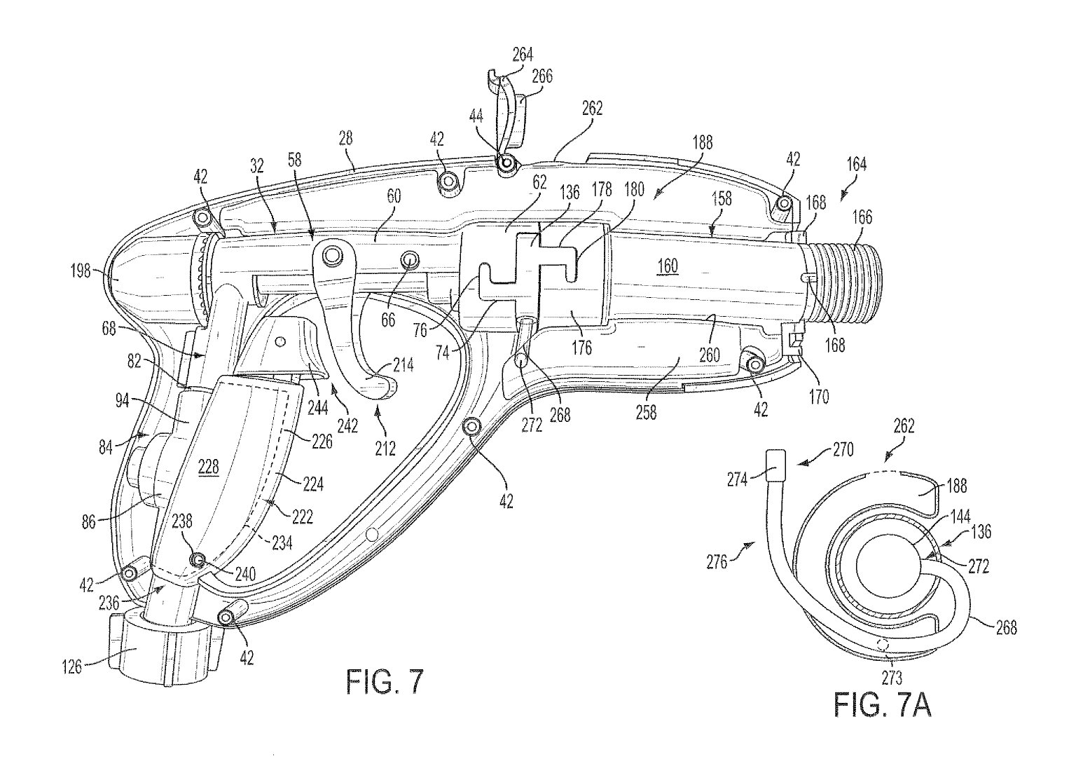

Referring now to FIGS. 1, 3, 4, 7 and 8, the dispensing assembly 32 includes a plurality of components that are secured together for directing the water and soap into the nozzle assembly 24. Specifically, a generally L-shaped dispenser 58 forms the central component of the dispensing assembly 32 and includes a semi-circular body 60, a front collar 62 and a rear collar 64 that are integrally formed with the body. Between the front and rear collars 62 and 64 are a pair of opposing pivot pins 66 projecting outwardly from the body 60 (FIGS. 4 and 7). The dispenser 58 also includes a valve connector 68 extending downwardly from the rear collar 64 that defines a through-hole 70 for directing incoming water into the dispenser.

As shown in FIG. 4, the front collar 62 of the dispensing assembly 32 includes an internal circular wall 72 that forms a tube or passageway extending through the front collar for directing water therethrough, where a diameter of the internal wall 72 is less than the a diameter of the front collar. The front collar 62 also defines a pair of opposing slots 74 and grooves 76 that are used to securely connect the dispenser 58 with another component of the dispensing assembly 32. Similarly, the valve connector 68 includes opposing connecting tabs 78 extending outwardly from its outer surface 80 and below a protruding seal ring 82 for connecting a bottom end of the valve connector to valve member 84.

Referring now to FIGS. 4, 8 and 12-14, the valve member 84 includes a tubular body 86 defining an interior flow channel 88 for directing water into the dispenser 58. A valve 90 is positioned in the flow channel 88 and moves between an open position for enabling water to flow through the valve member and a closed position that stops the flow of water through the valve member. It should be appreciated that the valve 90 may be any suitable flow control such as a conventional water valve. The valve member 84 also includes a pivot member 92 connected to an outer body surface 94 that defines opposing holes 96.

Operation of the valve 90 is controlled by an actuator, such as a button 98, and a valve post 100 connected to the button. Pressing inwardly on the button 98 causes the valve 90 to move to the open position and also causes the valve post 100 to move in a corresponding direction. Releasing the button 98 causes the valve 90 to move to the closed position, and causes the valve post 100 to move in the same direction as the button. To ensure that button 98 returns to its initial non-depressed position, the valve post 100 includes a radially extending flange 102 spaced inwardly from its outer end 104 and a biasing member, such as coil spring 106, positioned on the outer end for biasing the valve post, and thereby the button, to the initial non-depressed position. A cap 108 is positioned over the coil spring 104 and the outer end 102 of the valve post 98 to hold the coil spring in place on the outer end.

Each end of the valve member 84 defines opposing, generally vertical slots 110 and transverse grooves 112 that are used to connect the valve member to the other components of the dispenser. One end 114 of the valve member 84 is connected to the bottom of the dispenser body 60 by sliding the connecting tabs 78 downwardly into the corresponding slots 110 until the valve member engages the seal ring 82, and then twisting or turning the valve member so the connecting tabs move into the opposing grooves 112. An opposing end 116 of the valve member 84 is connected to a hose adapter 118 using the same connection method.

Referring now to FIGS. 4 and 12-14, the hose adapter 118 includes an outer wall 120 having a diameter and defining an internal flow channel 122 that communicates with the flow channel 88 of the valve member 84. A flange 124 is integrally formed with and radially extends from an end of the hose adapter 118 for securing a rotating female hose connector 126. Specifically, the hose connector 126 includes a peripheral wall 128 and defines an opening 130 with a diameter that is larger than the diameter of the outer wall 120 of the hose adapter 118 so that the hose connector fits over the outer wall as shown in FIG. 7.

To secure the hose connector 126 to the hose adapter 118, the flange 124 has a diameter that is greater than the diameters of the outer wall 120 and the opening 130 but less than an inner diameter 132 of peripheral wall 128. After being secured to the hose adapter 118, the hose connector 126 freely rotates relative to the hose adapter so that the hose connector can be screwed onto a threaded end of a hose or similar water source. As shown in FIG. 4, an opposing end of the hose adapter 118 includes a pair of opposing connecting tabs 134 that slide within slots 74 and grooves 76 on the valve member 84 as described above for securing the hose adapter to the valve member.

Referring now to FIGS. 4, 7, 8 and 12-14, a soap receiving member 136 is connected to the dispensing assembly 32 by engaging connecting tabs 138 at one end into the corresponding slots 74 and grooves 76 on the front collar 62 of the body 60. Opposing rectangular spacers 140 project from an outer surface 142 of the soap receiving member 136 and engage the end of the dispenser body 60 to limit movement of the soap receiving member relative to the dispenser body. Additionally, inside of the soap dispensing member 136 is an inner tube 144 having a diameter that is greater than the outer diameter of the wall 72 located inside the front collar 62 of the dispenser body 60 such that the inner tube 144 sealingly engages an outer surface of the wall 72 when the soap dispensing member and the body are connected together. The soap receiving member 136 defines a through-hole 148 for directing soap into the water flowing through the soap receiving member. An opposing end of the soap receiving member 136 includes a pair of opposing connecting tabs 146 for connecting it to another component as described below.

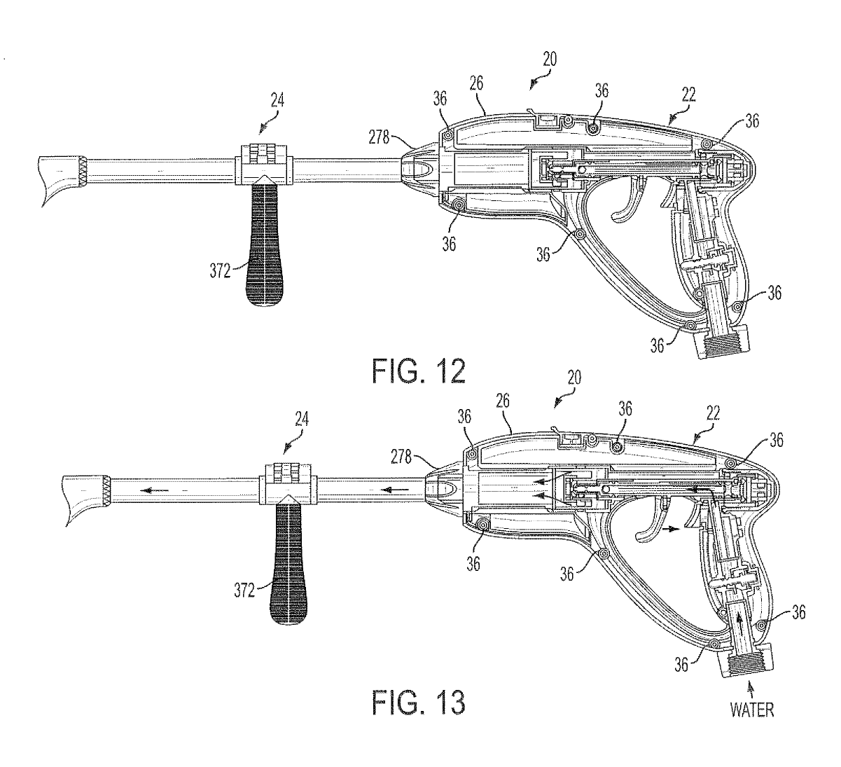

Referring to FIGS. 4 and 12-14, a sealing assembly 150 including a circular first seal member 152, a second beveled seal member 154 and an internal seal ring 156 are inserted into the inner tube 144 of the soap receiving member 136. As shown in FIGS. 12-14, the seal members 152 and 154, and the seal ring 156 combine to define a central through-hole 157 for directing soap into the water flowing around the seal assembly 150. The first and second seal members 152 and 154, and the seal ring 156 are preferably made of a durable rubber or plastic. It should be appreciated that the seal members 152 and 154, and the seal ring 156 may be made out of any suitable material or combination of materials.

Referring now to FIGS. 4, 7 and 12-14, a nozzle connector 158 has an outer wall 160 that defines an internal flow channel 162 for directing water or a mixture of soap and water to the nozzle assembly 24. A front end 164 of the nozzle connector 158 extends through the front opening 50 of the housing 22 and includes a plurality of threads 166 and four equally spaced projecting tabs 168 extending from the outer wall 160. An alignment guide 170 also projects from the outer wall 160 of the nozzle connector 158 and has a circular end portion 172 that aligns with a corresponding shaped recess 174 (FIG. 4) defined by the housing 22 for aligning the dispensing assembly 32 with the housing 22.

In the illustrated embodiment, a rear end of the nozzle connector 158 has a collar 176 defining a pair of opposing slots 178 and grooves 180 as described above. An inner diameter of the nozzle collar 176 is greater than an outer diameter of the soap receiving member 136 so that the collar frictionally engages the soap receiving member as the connecting tabs 146 are inserted into the slots 178 and grooves 180 of the nozzle connector. The nozzle connector 158 further includes internal tabs 182 that project inwardly from an inner surface 184 of the outer wall 160 and engage the first seal member 152 to hold the first seal member 152, the second seal member 154 and the seal ring 156 in position after assembly.

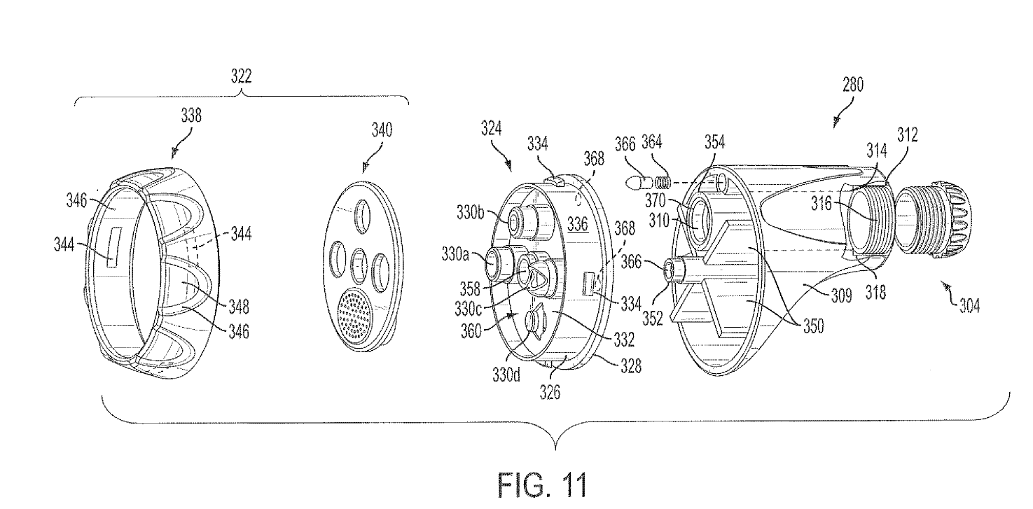

Referring to FIGS. 4, 7, 8 and 12-14, a soap dispenser 186 enables a user to efficiently dispense soap from a soap reservoir 188 and into the water flow during operation of the spray washer 20. The soap dispenser 186 includes a graduated, hollow dispensing rod 190 having a first diameter and an actuator portion 192 having a second diameter that is less than the first diameter. In operation, water enters through inlet openings 193 at one end of the rod 190 and flows through the rod to outlet openings 195 at an opposing end of the rod, and then into the soap dispenser 186. As shown in FIGS. 11-13, the rod 190 is configured to be inserted through the rear collar 64, the body 60 and the front collar 62 of the dispenser 58 so that the actuator portion 192 sealingly engages the through-hole 157 defined by the first seal member 152, the second seal member 154 and the seal ring 156.

After connecting the rod 190 to the dispenser 58, a generally T-shaped biasing member 194 is attached to an end of the rod and held in position by an inner cap 196. An outer cap 198 fits over the inner cap 196 and has internal threads 200 that engage corresponding threads 202 on the rear collar 64 to secure the rod 190, the biasing member 194 and the inner cap 196 in position relative to the dispensing assembly 32. A pair of flanges 204 protrudes from the soap dispensing rod 190 and define a space therebetween for receiving a Y-shaped clip 206. The clip 106 is made of a resilient plastic material and has curved arms 208 that extend around and frictionally engage a curved outer surface 210 of the soap dispensing rod 190. After connection, the clip 206 extends downwardly from the soap dispensing rod 190.

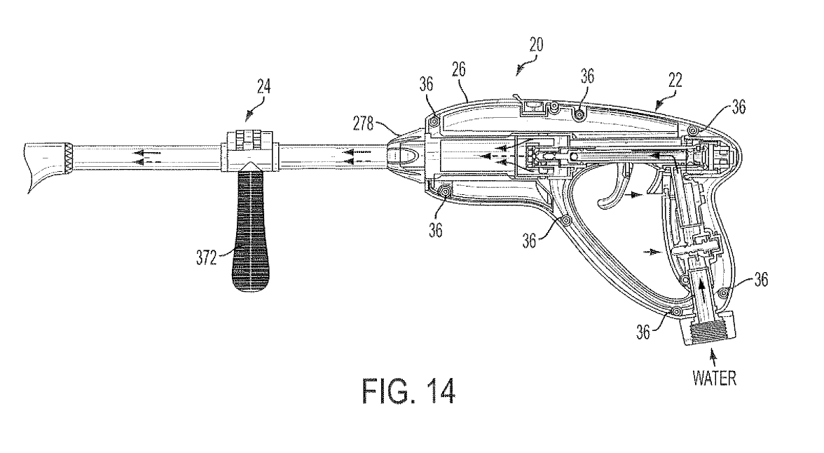

As shown in FIG. 4, a soap actuator, such as soap trigger 212, controls the movement of the rod 190 and has a curved finger portion 214 at a bottom end and a clevis 216 at a top end. The clevis 216 includes spaced arms 218, each defining a through-hole 220 that respectively engages the pivot pins 66 extending outwardly from opposing sides of the body 60 for enabling the soap trigger to pivot relative to the body 60 and move between a rest position (FIG. 12) and a dispensing position (FIG. 14). The clip 206 is positioned behind the soap trigger 212 so that when the soap trigger is pulled rearwardly by pressing a finger or fingers against the finger portion 214, it pushes against the clip which causes the soap dispensing rod 190 to move rearwardly against the biasing member 194. When the soap trigger 212 is released, the biasing member 194 expands and pushes the soap dispensing rod 190 forward, which in turn, respectively moves the clip 206 and the soap trigger 212 in the same direction.

Referring now to FIGS. 1, 4, 7 and 8, a water actuator or handle 222 is pivotably connected to the valve member 84 for controlling the flow of water through the spray washer 20. The handle 222 includes a generally U-shaped body 224 formed by a front wall 226 and two sidewalls 228, and a clevis connector 230 extending from a top end 232 of the handle. An internal space 234, defined by the front and sidewalls 226 and 228 of the body 224, is configured to fit over the valve member 84 and hose adapter 118 (see FIGS. 4 and 7). At a bottom end 236, the handle 222 defines a pair of opposing openings 238 that are aligned with the holes 96 on the pivot member 92. A suitable fastener, such as a screw or rivet 240, is inserted through the openings 238 and the holes 96 to pivotably secure the handle 222 to the valve member 84. In operation, the handle 222 pivots between a rest position (FIGS. 1, 7 and 12) and an actuation or dispensing position (FIG. 13) where an inner surface of the handle 222 contacts the button 98 to move the valve 90 to the open position. When the handle 222 is released, the spring 106 on the valve post 100 expands to respectively move the valve post 100 and the button 98 toward the handle 222.

During operation of the spray washer 20, it is desirable to temporarily secure or lock the water actuating handle 222 in the actuation position using a handle lock 242 if the water will be needed over an extended period of time. The handle lock 242 includes a generally U-shaped body 244 and defines a pair of opposing holes 246 that are sized to receive the opposing posts 248 on the clevis connector 230. A top surface 250 of the handle lock 242 includes a ridge 252 with a flat surface 254 that engages a tab 256 extending downwardly from the rear collar 64 of the dispenser body 60. When the ridge 252 engages the tab 256, the handle 222 is locked in the actuation position. To release the handle lock 242, a user pushes downwardly on a front surface 258 of the lock 242 to pivot it downwardly to disengage the ridge 252 from the tab 256. This allows the handle lock 242 and the handle 222 to move outwardly away from the valve member 84 to the initial rest position shown in FIG. 12.

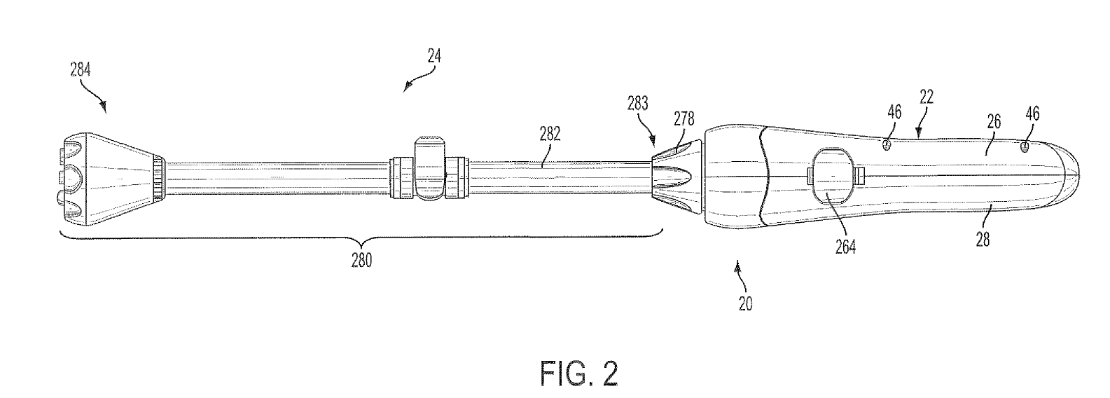

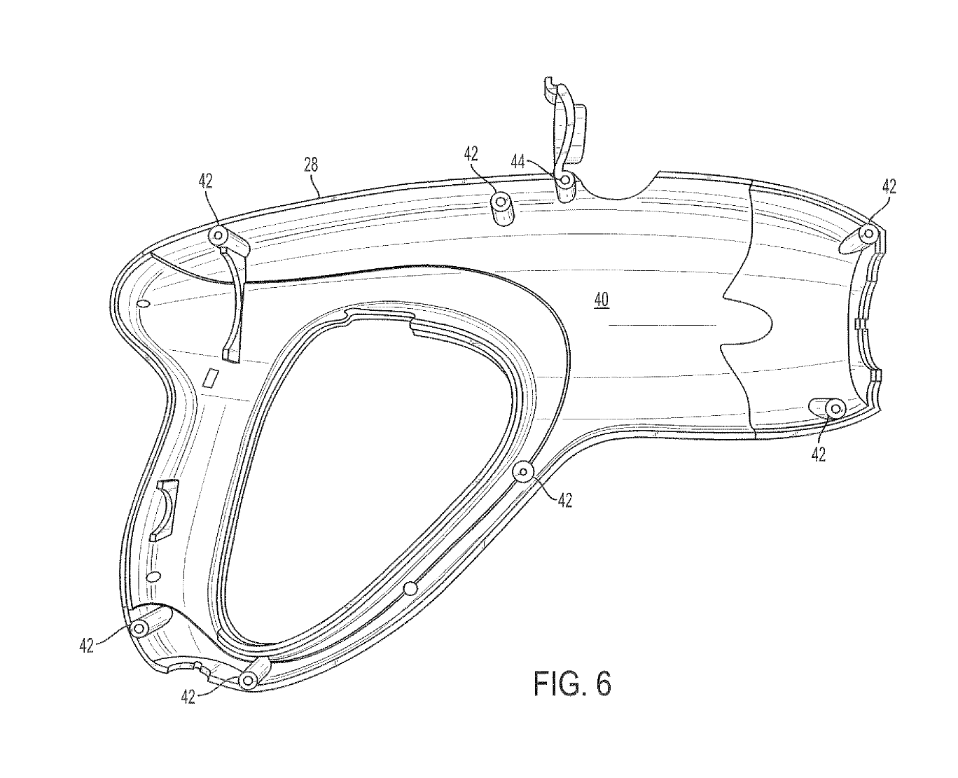

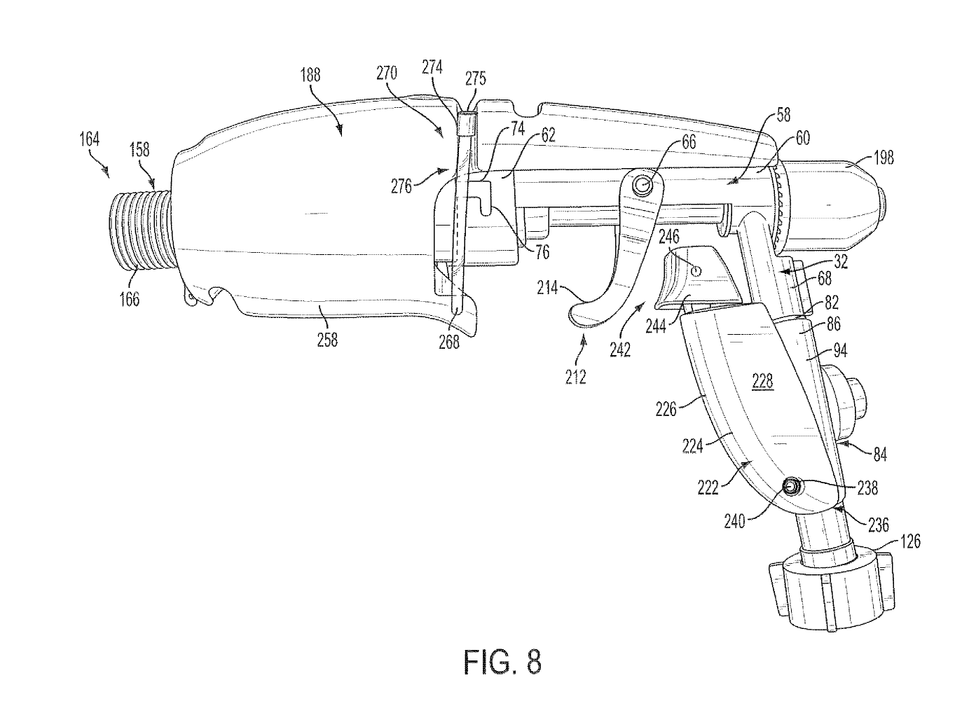

Referring now to FIGS. 4, 7, 7A and 8, the soap reservoir 188 has a generally elongated U-shaped body 258 defining an internal compartment for storing liquid soap. It should be appreciated that the reservoir 188 is made of a durable plastic but may be made out of any suitable material or combination of materials. An internal channel or internal groove 260 is defined by the body 258 and is sized to fit over and substantially surround the nozzle connector 158 and the soap receiving member 136 as shown in FIGS. 7 and 8. The reservoir 188 also defines a top opening 262 that aligns with the top opening 48 of the housing 22 for enabling a user to fill the reservoir with the liquid soap. A cover 264 is pivotably connected to the pin 44 extending from the first housing member 26 and is made of resilient rubber-like plastic or other suitable material. The cover 264 pivots relative to the housing 22 between an open position (FIG. 6) and a closed position (FIGS. 1 and 2). To enhance the seal between the cover 264 and the soap reservoir 188, the cover includes an annular ring 266 extending from a bottom surface 268 of the cover that frictionally engages the reservoir 188 to close and seal the top opening 262 and prevent soap from leaking or spilling out of the reservoir during use.

Soap is directed from the reservoir 188 using a soap dispensing tube 268, which is inserted through a bottom portion of the reservoir as shown in FIGS. 7 and 8. The tube 268 includes opposing ends 270 and 272 and defines a supply hole 273 (FIG. 7A) positioned between the ends. A first end 270 of the tube 268 extends outwardly from a side of the reservoir 188 and is sealed by a cap 274 having a pin-sized hole 275 (FIG. 8) to form a vent portion 276 of the tube. The hole 275 allows air to enter the first end 270 of the tube 268. It should be appreciated that the one or more holes 275 may be defined by the cap 274. The vent portion 276, and more specifically, the tube 268 varies in length and diameter depending on the size of the soap reservoir 188. As shown in FIGS. 7 and 8, the tube 268 passes through the soap reservoir 188 so that the supply hole 273 is exposed to the soap, and as the tube exits the reservoir, the second end 272 is inserted into the through-hole 157 of the soap receiving member 136. The through-hole 157 extends into the inner tube 144 for supplying soap from the reservoir 188 to the water flowing through the inner tube.

In operation, the dispensing rod 190 closes off or seals the through-hole 157 when the soap trigger 212 is in the rest or non-depressed position (FIG. 12) so that no soap enters the water flowing through the inner tube 144 thereby providing a “clean” rinse or clean water flow through the spray washer. When the soap trigger 212 is depressed, the dispensing rod 190 retracts to position the actuator portion 192 adjacent to the end of the through-hole 157. As described above, the actuator portion 192 has a smaller diameter than the diameter of the rod and therefore does not engage the inner surface of the inner tube 144 for closing off the through-hole 157. Since the through-hole 157 is at least partially open to the interior of the soap receiving member 136, soap flows from the through-hole and into the water flowing through the inner tube 144 by the Venturi effect, or vacuum created by the flowing water. More specifically, the pressurized water flows through the dispenser body 60 and the soap receiving member 136 at a relatively high velocity, creating a vacuum within the soap receiving member. This vacuum or suction draws the liquid soap from the through-hole 157 and the soap reservoir 188 and into the water flowing through the soap receiving member 136. The vent portion 276 of the tube 268 receives ambient air through the hole 275 for enhancing the flow of the soap from the reservoir 188 as the air is drawn into the reservoir by the vacuum.

As shown in FIGS. 1-4 and 7-8, the dispensing assembly 32 is inserted within the housing 22 so that the handle 222 extends through the handle opening 54, the soap trigger 212 extends through the trigger opening 56, the hose adapter 118 extends through the bottom opening 52 and the threaded end of the nozzle connector 158 extends through the front opening 50. As described below, a nozzle assembly 24 is connected to an end of the nozzle connector 158 and is secured in place by a housing collar 278 which includes internal threads 279 that matingly engage the external threads 166 on the nozzle connector.

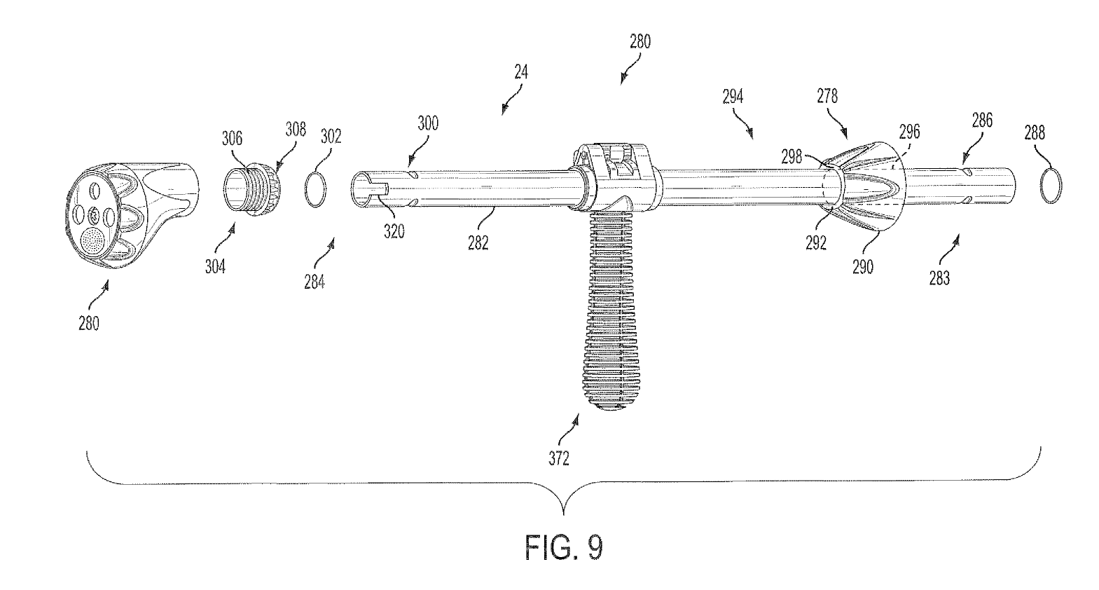

Referring now to FIGS. 1-3, 9-11, the nozzle assembly 24 directs the water and soap from the dispensing assembly 32 out through a nozzle 280 having different spray settings for washing and rinsing items. As described above, the nozzle assembly 24 includes an elongated tube 282 with a first end 283 and a second end 284 having an annular groove 286 and an o-ring 288 placed in the groove. The housing collar 278 includes an outer flared wall 290 and an end wall 292 that are integrally formed. As shown in FIG. 9, the end wall 292 defines an opening 294 leading to an inner space 296 defined by the outer wall 290. The housing collar 278 is rotatably attached to the elongated tube 282 by sliding the tube through the opening 294 and the inner space 296 of the collar until the collar is past the groove 286. Then, as stated above, the o-ring 288 is positioned in the groove 286 and the collar 278 is slid over the o-ring 288 so that the o-ring is positioned within the inner space 296 and abuts an inner surface 298 of the end wall 292. As such, the o-ring 288 prevents the housing collar 278 from sliding off of the end 283 of the tube 282 and also forms a seal between the collar 278 and the nozzle connector 158 when the collar and nozzle connector are connected together.

Referring now to FIGS. 1, 9 and 11, the nozzle 280 is connected to the second end 284 of the tube 282 where the end 284 includes an annular groove 300 for receiving an o-ring 302. A connector 304 having external threads 306 and defining a through-hole 308 having a diameter that is slightly larger than the diameter of the tube 282 is slid over the end 284 of the tube and past the annular groove 300. The o-ring 302 is then positioned in the groove 300 to prevent the connector 304 from sliding off of the end 284 of the tube 282 and also for forming a seal between the connector and the nozzle 280. As shown in FIG. 11, the nozzle 280 includes a body 309 defining a through-hole 310 that leads into a receptacle 312 having a diameter that is larger than a diameter of the through-hole 310, an inner shoulder 314 and internal threads 316. The receptacle 312 has a protrusion 318 and an inside diameter that is larger than the diameter of the tube 282 such that the end 284 of the tube is inserted into the receptacle 312 until the protrusion 318 engages a notch 320 (FIG. 9) on the end 284 of the tube 282 and the o-ring 302 engages the inner shoulder 314. The connector 304 is then screwed into the nozzle 280 to secure the nozzle to the end 284 of the tube 282 by turning the connector relative to the nozzle so that the external threads 306 matingly engage the internal threads 316.

Referring to FIG. 11, a spray setting selector 322 includes a base member 324 having an annular wall 326 and an annular flange 328 extending from the wall. A plurality of generally cylindrical spray outlets 330a, 330b, 330c and 330d extending from a surface 332 of the base member 324 and may have a different inside diameter, such as outlets 330a and 330b, or an obstructed opening, such as outlets 330c and 330d, which change the configuration of the water sprayed from the nozzle. A plurality of spaced tabs 334 extend transversely from an outer surface 336 of the wall 326 and are used to connect a grip ring 338 to the base member 324 as described below. A nozzle plate 340 is secured to the base member 324 by aligning the spray outlets 330a, 330b, 330c and 330d with corresponding holes 342 on the plate 340 and then sliding the outlets through the holes such that the frictional engagement between the outlets and holes securely attaches the plate 340 to the base member 324.

The grip ring 338 is attached to the base member 324 and the plate 340 by sliding the ring over the plate and base member so that the tabs 334 on the base member 324 fit into grooves 344 defined by an inner surface 346 of the ring 338. The ring 338 is preferably made out of rubber or a similar non-slip material for enabling a user to easily grip the ring. Additionally, the nozzle ring 338 has a plurality of protrusions 346 and recessed surfaces 348 for making it easier for a user to grip the ring for rotating the spray setting selector 322 as described below.

As shown in FIG. 11, the body 309 of the nozzle 280 includes four equally spaced planar vanes 350, a post 352 in the middle of the vanes, an outlet opening 354 at an end of the through-hole 310 and a receptacle 312. The base member 324 includes a central through-hole 358 and a recessed area 360 defined by an annular wall 326 where the spray setting selector 322 is rotatably connected to the body 309 by inserting the post 352 through the through hole 304 and positioning the vanes 350 in the recessed area 360 so that the vanes are adjacent to the wall 326. A fastener, such as screw 364 (FIG. 1), is inserted into a threaded hole 366 defined by the post 352 and fastened therein to secure the spray setting selector 322 to the body 309.

To choose a particular spray outlet 330a, 330b, 330c or 330d, a user rotates the spray setting selector 322 until the desired spray outlet is aligned with the outlet opening 354 on the body 309. The spray setting selector 322 is temporarily secured in position by a biasing member, such as spring 364, and an indexing pin 366. As shown in FIG. 11, the indexing pin 366 engages indentations 368 aligned with each spray outlet 330a, 330b, 330c and 330d to secure the spray setting selector 322 at that position. When the spray setting selector 322 is rotated, the pin 366 moves out of a respective indentation 368 and into another indentation 368 while the spring 364 biases the pin 366 against the bottom surface of the spray setting selector 322 to ensure that the pin stays engaged with the indentation until the spray setting selector is rotated again. A suitable o-ring 370 is positioned in the outlet opening 354 to form a seal between the outlet opening and a selected spray outlet 330a, 330b, 330c or 330d of the spray setting selector 322. Additionally, indicia (not shown) such a word describing a type of spray or operation, such as “rinse,” “prep,” “blast” or “soap,” is imprinted on the nozzle ring 343 to make it easier for a user to select and use one of the spray settings of the spray washer 20.

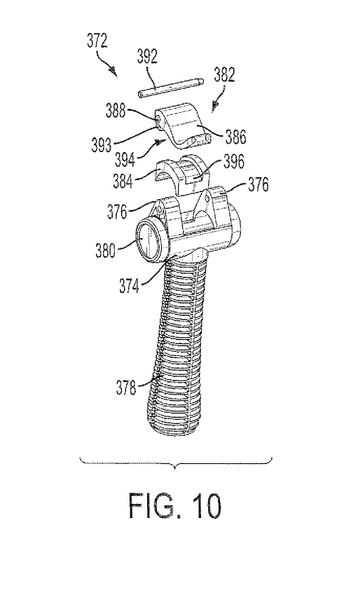

Referring now to FIGS. 9 and 10, to help a user securely hold the spray washer during operation, an adjustable handle 372 is attached to the tube 282. The handle 372 includes a body 374 having spaced, triangular supports 376 and a grip 378. The body 374 defines a through-hole 380 having an inside diameter that corresponds to the diameter of the tube 282 so that the handle 372 can be connected to the tube by sliding the tube through the through-hole 380. Once the handle 372 is in a desired position on the tube 282, a user secures or locks the handle in position without the use of tools by using a locking mechanism 382 attached to the handle 372.

The locking mechanism 382 includes a u-shaped compression member 384 that is inserted between the supports 376 and engages the outer surface of the tube 282. A lever 386 including a through-hole 388 is secured to the handle 372 above the compression member 384 by aligning the through-hole 388 with through-holes 390 defined by the supports 376 and then inserting a pin 392 through the through-holes 388 and 390 of the supports 376 and the lever 386. This allows the lever 386 to pivot between a locked position and an unlocked position. To lock the handle 372 at a desired position, the lever 386 is moved to the locked position which causes a cam-like protrusion 393 on a bottom surface 394 of the lever 386 to engage a top surface 396 of the compression member, thereby tightly pressing the compression member 384 against the outer surface of the tube 282. The compression pressure generated between the compression member 384 and the tube 282 securely holds the handle 372 in position. To move the handle 372 to a different position, the lever 386 is moved to the unlocked position to release the compression pressure between the compression member 384 and the tube 282 and allow the handle 372 to freely slide along the tube 282.

Referring now to FIGS. 12-14, a user depresses the handle 222 to open the valve 90 and allow pressurized water to flow upwardly through the hose connector 126, the hose adapter 118 and the dispensing assembly 32. The water then flows through the tube 282 and out from the nozzle 280. To lock the handle 222 in this position for prolonged use of the spray washer 20, a user depresses the handle lock 242 to engage the ridge 252 on the handle lock with the tab 256 on the housing 22. To release the handle lock 242, the user presses the lower portion of the handle lock, which pivots the handle lock so that the ridge 252 disengages from the tab 256 and allows the handle lock 242 and the handle 222 to move outwardly to the rest position (FIG. 12). Releasing the handle 222 releases pressure on the button 98 of the valve member 84 and closes the valve 90 to prevent water from flowing through the valve member.

As shown in FIG. 14, soap is dispensed from the spray washer 20 by depressing inwardly on the soap trigger 212. This action causes the clip 206, and thereby the dispensing rod 190 to move inwardly against the force of the spring 194. The rearward movement of the rod 190 disengages the actuator portion 192 of the rod from the sealing assembly 150 to efficiently allow a distinct quantity of soap to enter the water flow from the soap reservoir 188 using a vacuum generated in the soap receiving member 136. The soap mixes with the flowing water to emit a soapy spray onto an item being cleaned or washed.

To stop the flow of soap into the water flow, a user releases the soap trigger 212, which causes the dispensing rod 190 to move forwardly due to the expanding force of the spring 194. The actuator portion 192 of the dispensing rod 190 moves into the aligned through-hole 157 of the sealing members 152 and 154 and the seal ring 156 to form a seal therein and close the soap dispensing tube 258. This seal prevents the soap from entering the water flow from the soap reservoir so that clean, soap-free water, i.e., a clean rinse, is applied to an item for rinsing. Also, the efficient opening and closing of the soap dispensing tube 258 significantly reduces the amount of residual soap left in the spray washer 20 such that the present spray washer quickly changes from a soap dispensing mode to a water rinsing mode and conserves the stored soap in the soap reservoir 188.

The soap trigger 212 and the handle 222 are returned to their respective initial, rest positions (FIG. 12) to stop the flow of soap and water from the spray washer 20.

While a particular embodiment of the present soap nozzle has been described herein, it will be appreciated by those skilled in the art that changes and modifications may be made thereto without departing from the invention in its broader aspects and as set forth in the following claims.

1. A spray washer comprising:
a dispensing assembly including a water inlet connected to a pressurized water source and a spray outlet, said dispensing assembly including a water actuator movable between a rest position and a dispensing position, wherein when said water actuator is moved to said dispensing position, water from the pressurized water source enters the water inlet, flows through the dispensing assembly and exits from the spray outlet;
a soap reservoir including a soap outlet and in communication with said dispensing assembly; and
a soap actuator movable between a rest position and a dispensing position, wherein when said soap actuator is moved from said dispensing position to said rest position, said soap outlet is closed off and soap-free water exits the spray outlet.

2. The spray washer of claim 1, wherein said water actuator includes a handle and a handle lock connected to said handle, wherein said handle lock secures said handle in said dispensing position.

3. The spray washer of claim 1, further comprising a soap dispensing tube including a first end having a vent, an opposing second end connected to said dispensing assembly, and a supply hole positioned between said first and second ends for transferring soap from said soap reservoir to said dispensing assembly.

4. The spray washer of claim 1, further comprising a nozzle assembly including a nozzle and an adjustable handle.

5. A handheld spray washer comprising:
a housing;
a dispensing assembly positioned in the housing and including a water inlet connected to a pressurized water source and a spray outlet, said dispensing assembly including a water actuator movable between a rest position and a dispensing position, wherein when said water actuator is moved to said dispensing position, water from the pressurized water source enters the water inlet, flows through the dispensing assembly and exits from the spray outlet;
a soap reservoir is positioned in said housing and is in communication with said dispensing assembly, said soap reservoir including a soap outlet; and
a soap actuator movable between a rest position, wherein said soap outlet is closed off from said dispensing assembly, and a dispensing position, wherein said soap outlet is at least partially open to said dispensing assembly, wherein when said soap actuator is moved to said dispensing position, soap is drawn from the soap reservoir and mixed with the water flowing through said dispensing assembly by a vacuum created within said dispensing assembly.

6. The handheld spray washer of claim 5, further comprising a valve positioned between said inlet and said outlet of said dispensing assembly, wherein said valve is closed when said water actuator is in the rest position, and said valve is open when said water actuator is in said dispensing position.

7. The handheld spray washer of claim 5, further comprising an actuator lock connected to said water actuator, said lock configured to releasably engage said housing for temporarily securing said water actuator in said dispensing position.

8. The handheld spray washer of claim 5, further comprising a soap receiving member connected to said dispensing assembly and a tube connected to said soap reservoir and said soap receiving member, said tube configured to transfer soap from said soap reservoir to said soap receiving member when said soap actuator is moved to said dispensing position.

9. The handheld spray washer of claim 8, wherein said tube includes two ends, one of said ends includes a vent portion, and the other end of said tube is connected to said soap receiving member.

10. The handheld spray washer of claim 8, wherein an intermediate portion of said tube includes a soap inlet positioned at a bottom end of said soap reservoir.

11. The handheld spray washer of claim 5, further comprising a nozzle assembly connected to said outlet of said dispensing assembly, said nozzle assembly including an adjustable nozzle at one end and a collar rotatably connected to an opposing end for connecting said nozzle assembly to said outlet of said dispensing assembly.

12. The handheld spray washer of claim 11, further comprising an adjustable handle movably connected to said nozzle assembly, said adjustable handle including a handle lock for locking said adjustable handle at a position on said nozzle assembly.

13. A handheld spray washer comprising:
a housing;
a dispensing assembly positioned in the housing and connected to a pressurized water source;
a soap reservoir positioned in said housing and in communication with said dispensing assembly;
a water actuator movably connected to said dispensing assembly and configured to control a valve in said dispensing assembly, wherein said water actuator is movable between a rest position, wherein said valve is in a closed position and water is prevented from entering the dispensing assembly, and a dispensing position, wherein said valve is in an open position to allow water to enter said dispensing assembly;
a soap actuator movably connected to said dispensing assembly, said soap actuator being movable between a rest position, wherein said reservoir is sealed and soap is prevented from entering said dispensing assembly, and a dispensing position, wherein reservoir is not sealed and said soap is drawn into said dispensing assembly by a vacuum; and
a nozzle assembly connected to said dispensing assembly for directing water flowing through said dispensing assembly or a combination of water and soap onto an item when one of said water actuator and a combination of said water actuator and said soap actuator are moved from said rest position to said dispensing position.

14. The spray washer of claim 13, wherein said nozzle assembly includes a tube having a first end and a second end, a collar rotatably connected to said first end of said tube for connecting said tube to said dispensing assembly, and a nozzle connected to said second end of said tube.

15. The spray washer of claim 14, wherein said nozzle is adjustable to one of a plurality of spray settings.

16. The spray washer of claim 14, further comprising an adjustable handle connected to said tube.

17. The spray washer of claim 13, further comprising a tube connected to said soap reservoir, a first end of said tube includes a vent portion and a second end of said tube is connected to said dispensing assembly for transferring soap to said dispensing assembly.

18. The spray washer of claim 13, further comprising a locking mechanism connected to said water actuator, said locking mechanism being movable between an unlocked position and a locked position, wherein said locked position locks said water actuator in said dispensing position.
